(19) United States
(12) Patent Application Publication
(10) Pub. No.: US 2026/0095433 A1
(43) Pub. Date: Apr. 2, 2026

(54) EMAIL DELIVERY AND TRACKING VIA AN EXTERNAL EMAIL SERVER PLATFORM

(71) Applicant: Check Point Software Technologies, Ltd., Tel Aviv (IL)

(72) Inventors: Roy ROTEM, Tel Aviv (IL); Michal YEHUDAR, Tel Aviv (IL); Yair YOGEV, Raanana (IL)

(73) Assignee: Check Point Software Technologies, Ltd., Tel Aviv (IL)

(21) Appl. No.: 18/901,075

(22) Filed: Sep. 30, 2024

(51) Int. Cl. H04L 51/234; H04L 9/40

(52) U.S. Cl. CPC H04L 51/234; H04L 63/1483

(57) ABSTRACT

A device, system, and method are provided for managing an email training campaign using an application programming interface (API) to send a monitored emails that bypass an email filter of an external email server platform. User interaction with the monitored email is tracked by the computer device receiving status updates of user interactions with the monitored email from the external email server platform.

### TECHNICAL FIELD

The present disclosure relates generally to email delivery and more particularly to email delivery for user security training.

### BACKGROUND

Organizations increasingly rely on email communication for various purposes, including training employees on important security practices. A common practice involves sending training videos for users to complete and pseudo-phishing emails to simulate phishing attacks, which aim to train users to recognize and appropriately handle potential threats.

Delivering these training emails via standard email protocols, such as SMTP, can be problematic, because these emails are often classified as spam or advertisements by Mail Transfer Agents (MTAs) and security filters. As a result, the training emails may be filtered out or end up in junk folders, reducing the likelihood that users will engage with them. Additionally, even if the emails reach the user's inbox, they are often ignored, marked as read, or deleted without being opened, diminishing the effectiveness of the training campaign. To overcome this IT spends a lot of time configuring/whitelisting etc. to ensure deliverability. Also part of this type of service involves monitoring the end user interaction with the emails and specifically with simulations—this is very difficult to do via SMTP if at all.

### SUMMARY

To address these issues, there is a need for an improved solution that ensures the delivery and visibility of emails within an organization's email environment. Such a solution would increase the likelihood that users interact with these emails and, consequently, improve the overall effectiveness of training. The present disclosure introduces an infrastructure that leverages APIs within enterprise email platforms (such as Microsoft Office 365 and Google Workspace) to create, distribute, and manage training campaigns such as phishing simulations) more effectively. This approach bypasses the limitations of traditional email protocols and enhances user engagement with training content.

The present disclosure provides an electronic device, system, and method for managing an email training campaign and phishing simulations using an application programming interface (API) to send monitored emails that bypass an email filter (also referred to as a security filter) of an external email server platform and to receive status updates of user interactions with the monitored email.

Existing solutions for phishing simulations struggle to determine if a user has read or deleted an email, or if the email has been quarantined or forwarded to IT support, reported the email as phishing or spam etc. To track actions such as reporting an email as phishing, prior approaches often require the installation of custom buttons or plugins or relying on injecting images into the emails. There is a need for an improved solution that can seamlessly monitor user interactions using native functionalities—such as the built-in “Report Phishing” button—without the need for additional software installations.

The present disclosure introduces an infrastructure that leverages APIs within enterprise email platforms to accurately track user responses to simulated phishing emails. This approach enables the collection of detailed insights into user behavior, such as email reads, deletions, and phishing reports, enhancing the effectiveness of training programs without relying on external plugins or modifications.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the many ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a block diagram of an embodiment of a system for managing an email training campaign sent to a user including a computer device and an external email server platform.

FIG. 2 is a ladder diagram showing tracking a monitored email using status updates.

FIG. 3 is a ladder diagram showing generating and tracking a simulated phishing email.

FIG. 4 is a flow diagram of an embodiment of a method implemented by the computer device for managing an email training campaign sent to a user using the external mail server.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

The present disclosure provides a computer device, system, and method for managing an email training campaign using an application programming interface (API) to send a monitored emails that bypass an email filter of an external email server platform. User interaction with the monitored email is tracked by the computer device receiving status updates of user interactions with the monitored email from the external email server platform (e.g., by by polling the status of individual emails via the API).

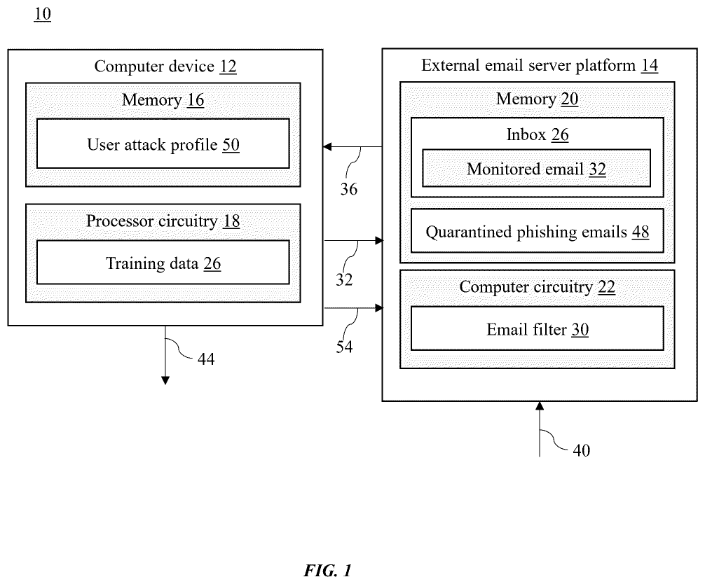

According to a general embodiment shown in in FIG. 1, a system 10 is presented for managing an email training campaign sent to a user. The system 10 includes a computer device 12 and an external email server platform 14. The computer device 12 includes memory 16 and processor circuitry 18. Similarly, the external email server platform 14 includes memory 20 and computer circuitry 22.

The external email server platform 14 stores an inbox 26 for the email address of the user in the memory 20. The computer circuitry 22 of the external email server platform 14 receives and executes requests formatted according to an application programming interface (API). The computer circuitry 22 also implements an email filter 30 to process incoming messages based on filtering criteria. For example, the email filter 30 may analyze incoming email messages to identify phishing messages, and relocate the identified phishing message into a junk folder.

The email filter 30 may refer to a range of configurations and functionalities designed to process and analyze incoming email messages based on predefined filtering criteria. For example, the email filter 30 may be implemented as software modules or hardware components within the external email server platform 14. These implementations may include spam filters, antivirus scanners, phishing detection algorithms, content filters, and other security mechanisms.

The computer device 12 communicates with the external email server platform 14 via the API (i.e., by sending requests to the external email server platform 14 according to the API). The processor circuitry 18 of the computer device 12 receives an email address of the user that the email training campaign is being sent. The processor circuitry 18 then sends (as a monitored email 32) an email to the user email address by initiating an API call to the external email server platform using the API. When sending the monitored email 32), the computer device 12 initiates an API call that bypasses the email filter 30 of the external email server platform 14 so that the monitored email 32 is received in the inbox 26 for the email address of the user.

Because email filters are designed to remove phishing emails from a user's inbox, fake phishing emails sent as part of a training campaign are often removed from a user's inbox by email filters. For this reason monitored emails 32 designed to look like phishing emails are often never seen by users because these fake phishing emails are filtered by the email filters. By sending emails via the API, the present disclosure avoids the email filter, ensuring that the monitored emails reach the user's inbox. That is, using API methods avoids issues posed by email filters by using API calls that avoid the email filter 30 and directly place the monitored email 32 in the user's inbox 26.

This API approach breaks away from the traditional limitations of SMTP. One of the goals of the present disclosure is to provide the same functionality (including the ability to send monitored emails without passing through the email filter) in different email environments (e.g. Office 365 and Google Workspace). This is achieved by utilizing the relevant API in each of these platforms.

In addition to the above-described benefits of using the API to avoid the email filter, using the API also eliminates the need for domain purchases, allowing the complete impersonation of any domain. That is, traditional methods of sending emails from an email address at a specific domain requires the sender to purchase the domain. This is because sending emails from a spoofed domain is likely to cause the email to not reach its target due to various intermediate and terminal controls. Purchasing domains is expensive and cumbersome and the present disclosure avoids this issue. Furthermore, certain domains, such as the organization's domain are typically not available for purchase. Furthermore, replies sent to nonexistent domains can be intercepted and analyzed, providing valuable insights for reporting purposes. The API also enables capturing native user responses, such as ‘report as phishing’ or ‘report as spam,’ across multiple platforms like Microsoft Office 365 and Google Workspace, utilizing their cross-device capabilities.

As is described in further detail below, the API also allows for real-time monitoring of user interactions with pseudo-phishing emails. This includes tracking whether emails are deleted, moved to a folder, opened, reported as phishing, or sent to the junk folder. Additionally, the API can prioritize emails by marking them as ‘unread’ to increase user responsiveness, avoiding the need to send duplicate copies. The API-based solution also enhances user interaction by allowing monitoring of user actions, such as clicking on links within the email.

The computer device 12 (i.e., the processor circuitry 18) tracks the monitored email by receiving status updates 36 from the external email server platform 14. That is, the external email server platform 14 (i.e., the computer circuitry 22) receives the email 32 in the inbox 26 for the email address of the user. The external email server platform 14 then sends to the computer device 12 the receipt of the monitored email 32 as a status update 36. That is, the external email server platform 14 sends a status update 36 to the computer device 12 indicating that the monitored email 32 has been received.

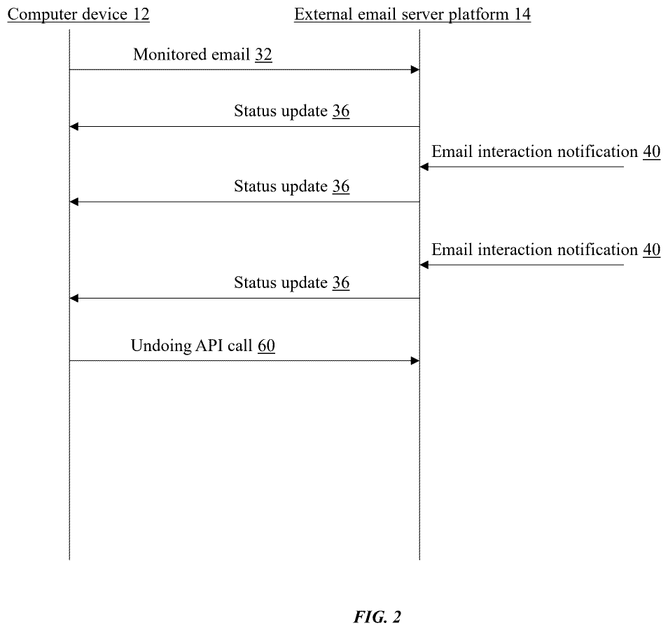

With exemplary reference to FIG. 2, in addition to status updates 36 indicating when a monitored message 32 is received, the external email server platform 14 also sends status updates 36 when the user interacts with the monitored email 32. That is, when the user interacts with the monitored email 32, the external email server platform 14 receives a notification of the user interaction (i.e., an email interaction notification 40) with the monitored email 32. For example, the user interaction may include at least one of opening the monitored email, moving the monitored email to a junk folder, deleting the monitored email, replying to the monitored email, or reporting the monitored email as a phishing email. The external email server platform 14 sends the received email interaction notification 40 to the computer device 12 as a status update 36.

The user may access and interact with emails stored in the inbox (e.g., the monitored emails 32) through various email clients that interface with the external email server platform 14. These email clients may include desktop applications such as Microsoft Outlook, mobile email apps on smartphones and tablets, or web-based clients accessed through internet browsers like Outlook Web Access (OWA) or Gmail's web interface. The user may retrieve emails from the inbox 26 stored on the external email server platform 14 by connecting via standard email protocols such as Internet Message Access Protocol (IMAP), Post Office Protocol version 3 (POP3), Hypertext Transfer Protocol (HTTP), or using proprietary protocols provided by the email service. Through these clients, the user can perform typical email actions on the monitored emails 32, such as reading, replying, forwarding, deleting, or reporting them as spam or phishing. The interactions made by the user are communicated back to the external email server platform 14, which records these actions and triggers the email interaction notifications 40.

The computer device 12 receives the status updates 36 from the external email server platform 14, and generates and outputs a dashboard 44 based on the received status updates 36. For example, the dashboard 44 may provide a comprehensive visualization of user interactions with the monitored emails 32. The dashboard 44 may display real-time metrics such as the number of emails opened, deleted, responded to, or reported as spam or phishing. The dashboard 44 may include graphical representations like charts, graphs, and tables to illustrate patterns and trends in user behavior over time. In this way, the dashboard 44 may integrate with the external email server platform 14 to provide real-time updates, ensuring that the displayed information is current and accurate.

The system 10 may send multiple monitored emails 32 to the user (e.g., as part of a comprehensive training campaign). These emails may be distributed over a scheduled period and can vary in content, appearance, and complexity to simulate different phishing scenarios and security threats. By sending multiple monitored emails 32, the system 10 may assess the user's ability to recognize and respond appropriately to a range of potential risks. Each monitored email 32 may be individually tracked, allowing the system 10 to collect detailed data on the user's interactions with each email, such as whether it was opened, ignored, deleted, or reported as spam or phishing.

In addition to individual user monitoring, the system 10 may send the monitored emails 32 to a plurality of users. That is, each user may receive multiple monitored emails 32 as part of a coordinated training campaign orchestrated by the processor circuitry 18. For example, the system 10 can distribute pseudo-phishing emails across a designated population of users, allowing it to monitor and analyze the actions taken by each user upon reception of these emails. The dashboard 44 may compile the status updates 36 received from the external email server platform 14 for all users, providing a comprehensive overview of user interactions with the monitored emails. This collective data may enable the system 10 to dynamically enhance the campaign by adjusting strategies and content based on user actions, thereby improving the training results. For example, if certain users or departments are frequently interacting with the simulated phishing emails in ways that indicate vulnerability—such as opening malicious links or failing to report suspicious emails—the system 10 can tailor subsequent emails or training materials to address these specific weaknesses.

The dashboard 44 may be used by administrators to drill down into specific data points, such as viewing which users reported an email as spam or which departments showed higher engagement with the monitored emails. The dashboard 44 may segment data based on various criteria like user roles, geographic locations, or time frames, enabling a more detailed analysis of user responses. In this way, the dashboard 44 may be used to assess the effectiveness of simulated phishing campaigns or training programs targeted at different user groups within the organization.

Additionally, the dashboard 44 may feature alert systems that notify administrators of critical actions taken by users, such as reporting an email as phishing. These alerts can prompt immediate follow-up actions, such as providing additional training or adjusting security protocols. The dashboard's comprehensive reporting capabilities facilitate informed decision-making to enhance email security measures and user awareness.

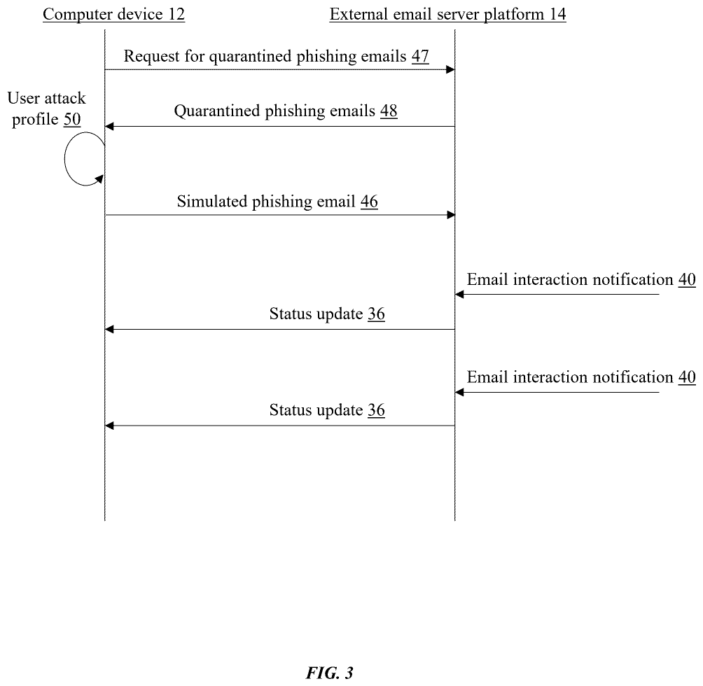

With exemplary reference to FIG. 3, the monitored email 32 may be a simulated phishing email 46, e.g., designed to closely replicate real phishing attempts that the user has previously encountered. In this embodiment, the computer circuitry 22 of the external email server platform 14 receives from the computer device 12 a request for quarantined phishing emails 47. Specifically, the computer device 12 sends a request to the external email server platform 14 for phishing emails that the user has previously received and that have been quarantined. The external email server platform 14 gathers the requested phishing emails and sends to the computer device 12 the requested quarantined phishing emails 48. The gathered phishing emails 48, may include various types such as financial phishing emails, emails impersonating trusted contacts or organizations, and emails containing malicious attachments or links.

Upon receiving the quarantined phishing emails 48 (e.g., indications about past attacks whether quarantined or not), the computer device 12 analyzes their properties to generate a user attack profile 50 based on, e.g., the types and characteristics of the received emails. For example, the quarantined phishing emails may include financial phishing emails that attempt to deceive the user into providing sensitive financial information, such as bank account numbers or credit card details. They may also include emails that impersonate legitimate financial institutions, online payment services, or invoice requests from fraudulent vendors. Other properties might involve phishing emails that mimic internal communications, such as emails appearing to come from company executives requesting urgent actions like wire transfers or confidential data disclosure.

The processor circuitry 18 may then create the simulated phishing email 46 based on the generated user attack profile 50, ensuring that the properties of the created email match those of the quarantined phishing emails 48. This may include replicating similar subject lines, sender addresses, formatting styles, and content themes to closely mimic the phishing tactics previously targeted at the user. For instance, if the quarantined emails frequently used urgent language prompting immediate action, the simulated phishing email may incorporate similar language to enhance realism.

By tailoring the simulated phishing email 46 to reflect the specific types of phishing attacks the user has encountered, the system provides a more effective training tool. It may help users become more aware of the specific threats they are likely to face, improving their ability to recognize and respond appropriately to actual phishing attempts in the future. This method enhances the overall cybersecurity posture by adapting to evolving phishing strategies and reinforcing user vigilance against personalized phishing schemes.

Additionally, the properties of the quarantined phishing emails may include technical details such as specific malware payloads, exploit techniques, or social engineering methods used to bypass security measures. The system can incorporate these elements into the simulated phishing email to test and strengthen the user's ability to detect and report sophisticated phishing attacks. By continuously updating the user attack profile 50 with new phishing email properties, the system ensures that the training remains relevant and effective against emerging threats.

Furthermore, the computer device 12 may use a library of template phishing attacks to use when generating simulated phishing emails. For example, the library may include a fixed number of predefined templates available, each template designed to mimic common phishing strategies such as deceptive financial requests, account verification prompts, or urgent security alerts. These templates may cover a wide range of scenarios and may be crafted to reflect realistic phishing tactics that users might encounter. In addition to using existing templates, the computer device may build new templates based on previously received phishing attacks. By analyzing actual phishing emails that have been quarantined or reported within the organization, the computer device 12 may create customized templates that mirror the latest phishing techniques targeting users.

In addition to ensuring that the monitored email 32 successfully reaches the inbox 26, the computer device 12 can enhance the visibility and prominence of the monitored email by manipulating various email attributes through API calls. This can be achieved either via the same API call used to send the monitored email 32 or through separate API calls dedicated to modifying email properties. Specifically, the computer device 12 may mark the monitored email 32 as important, pin its position to the top of the inbox 26, and/or set a reminder associated with the monitored email 32.

By marking the monitored email 32 as important, the system assigns a higher priority status to the email within the user's inbox. Email clients typically display important emails with visual indicators such as stars, flags, or bold text, making them stand out from regular messages. This visual emphasis draws the user's attention, increasing the likelihood that they will open and interact with the monitored email. This is particularly useful in environments where users receive a high volume of emails and might overlook standard messages.

Pinning the position of the monitored email 32 to the top of the inbox 26 ensures that the email remains prominently visible, regardless of any new incoming messages. This action overrides the default chronological sorting of emails, preventing the monitored email from being pushed down the list as new emails arrive. By maintaining the monitored email at the top, the system enhances user engagement by keeping the email within immediate view each time the user accesses their inbox.

Setting a reminder associated with the monitored email 32 involves configuring the email client to alert the user at a specified time or under certain conditions. This could include pop-up notifications, calendar events, or audible alerts reminding the user to read or respond to the email. Reminders are particularly effective for time-sensitive communications or when the system aims to assess the user's responsiveness over a period. By prompting the user through reminders, the system can gather data on how promptly users address important or flagged emails.

Moreover, utilizing these features may allow for more effective execution of training programs or simulated phishing campaigns. By increasing the visibility and perceived importance of the monitored email 32, the system 10 can better evaluate user behaviors such as their ability to recognize phishing attempts or their responsiveness to critical communications. The data collected from these interactions can be analyzed to identify patterns, measure the effectiveness of training initiatives, and inform future strategies for improving cybersecurity awareness within the organization.

With continued reference to FIG. 3, the computer device 12 may be configured to undo or disable certain user actions on the monitored email 32, effectively controlling how the user can interact with the monitored email 32. For example, the computer device 12 can make the monitored email persistent (also referred to as “sticky”) by preventing the user from performing actions such as deleting the email, moving it to a different folder, or marking it as read. This ensures that the monitored email remains prominently visible in the user's inbox 26, thereby increasing the likelihood of user engagement with the intended content.

By restricting these actions, the system 10 may guide the user towards only taking certain desired actions, such as clicking on a link within the email or reporting it as phishing. This selective allowance of user interactions may be particularly useful in training scenarios, where the objective is to assess or enhance the user's ability to recognize and appropriately respond to potential security threats. By keeping the monitored email in a persistent state, users are more likely to interact with it, providing valuable data on user behavior and response patterns.

Preventing the user from taking undesired actions may be accomplished by the computer device 12 initiating an undoing API call 60 whenever certain user actions are detected in a status update 36. For instance, when the system 10 receives a status update indicating that the user has deleted (also referred to as attempted to delete) the monitored email, the computer device 12 may respond by sending an undoing API call to the external email server platform 14 via the API. This API call reverses the effect of the user's action, causing the deleted email to reappear in the user's inbox 26. Similarly, if the user moves the email to a different folder or marks it as read, the undoing API call can reposition the email back to the inbox and reset its unread status. For example, when a user clicks a link, the undoing API call may respond to this link with a page showing information.

Reference to the processor circuitry 18 initiating an API call may refer to the processor circuitry 18 sending a request to the external email server platform 14 in accordance with a predefined API protocol. The request may be formatted according to the API's specifications, including parameters and data structures required for the external email server platform to process the request. Upon receiving the API call, the computer circuitry 22 of the external email server 14 may perform the corresponding actions, such as sending, receiving, or filtering emails, based on the operations defined by the API.

In one embodiment, the API facilitates a notification mechanism that enables the external email server platform 14 to send status updates 36 to the computer device 12 without requiring the computer device 12 to make separate requests for each update. In this embodiment, when the monitored email 32 is placed into the user's inbox 26, it is assigned a unique identifier that distinguishes it from all other emails. The computer device 12 may send a status update request 54 to the external email server platform 14, indicating its interest in receiving updates about any user interactions with the monitored email 32. This request can be included within the initial API call used to deliver the monitored email 32 to the inbox or can be sent as a separate API call.

As the user interacts with emails, any action taken on the monitored email 32—such as opening, deleting, replying, forwarding, or marking it as spam or phishing—may trigger an email interaction notification 40 within the external email server platform 14. This notification includes the unique identifier of the email involved in the interaction. The external email server platform 14 compares this unique identifier with those for which it has received status update requests.

When a match is found, indicating that the user has interacted with the monitored email 32, the external email server platform 14 may generate a status update 36 based on the details of the email interaction notification 40. This status update 36 is then sent to the computer device 12, providing real-time information about the specific action the user has taken. For example, if the user has reported the email as phishing using the built-in reporting features of their email client, this information is conveyed to the computer device 12 through the status update 36.

In another embodiment, the API facilitates a polling mechanism where the computer device 12 actively requests status updates from the external email server platform 14 (e.g., at regular intervals) regarding user interactions with the monitored email 32. After placing the monitored email 32 into the user's inbox 26, the computer device 12 assigns it a unique identifier. The computer device 12 then periodically sends status update requests 54 to the external email server platform 14, querying for any email interaction notifications 40 associated with that unique identifier. These status update requests can be sent at predetermined intervals or initiated based on specific conditions or events defined within the computer device 12.

Upon receiving a status update request 54, the external email server platform 14 may check for any user interactions involving the monitored email 32 since the last request. These interactions may include actions such as opening the email, deleting it, replying, forwarding, or marking it as spam or phishing. The external email server platform 14 compiles any relevant interaction data corresponding to the unique identifier and sends a status update 36 back to the computer device 12.

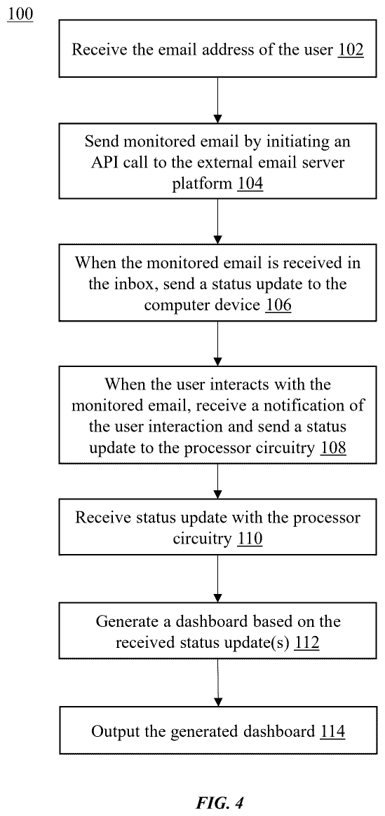

In the embodiment depicted in FIG. 4, a method 100 implemented by the processor circuitry 18 is shown for managing an email training campaign sent to a user using the external mail server 14 having an API. In step 102, the processor circuitry 18 receives the email address of the user. In step 104, the monitored email is sent to the user email address by initiating with the processor circuitry an API call to the external email server platform 14 using the API. The monitored email is received in an inbox for the email address of the user on the external email server platform after bypassing the email filter of the external email server platform.

In steps 106 and 108, the monitored email is tracked using status updates. In step 106, when the monitored email is received in the inbox for the email address of the user on the external email server platform, the external email server platform sends to the processor circuitry the receipt of the monitored email as a status update. In step 108, when the user interacts with the monitored email, the external email server platform 14 receives a notification of the user interaction with the monitored email as an email interaction and sends to the processor circuitry 18 the received email interaction notification as the status update.

In step 110, the processor circuitry 18 receives the status update. In step 112, the processor circuitry 18 generates a dashboard based on the received status updates. In step 114, the processor circuitry 18 outputs the generated dashboard.

The processor circuitry 18 and computer circuitry 22 may have various implementations. For example, the processor circuitry 18 and computer circuitry 22 may include any suitable device, such as a processor (e.g., CPU), programmable circuit, integrated circuit, memory and I/O circuits, an application specific integrated circuit, microcontroller, complex programmable logic device, other programmable circuits, or the like. The processor circuitry 18 and computer circuitry 22 may be located on one or more discrete and separate pieces of hardware. The processor circuitry 18 and computer circuitry 22 may also include a non-transitory computer readable medium, such as random-access memory (RAM), a read-only memory (ROM), an erasable programmable read-only memory (EPROM or Flash memory), or any other suitable medium. Instructions for performing the method described below may be stored in the non-transitory computer readable medium and executed by the processor circuitry 18 and computer circuitry 22. The processor circuitry 18 and computer circuitry 22 may be communicatively coupled to the computer readable medium and communication interface through a system bus, mother board, or using any other suitable structure known in the art.

The computer device 12 and the external email server platform 14 may both include a network interface for exchanging data—such as status requests, monitored emails, status updates, and other relevant information. That is, reference above to the computer circuitry or processor circuitry sending data may be accomplished by the computer circuitry/processor circuitry causing a respective network interface to send the data. Similarly, above reference to the computer circuitry or processor circuitry receiving data may be accomplished by the computer circuitry/processor circuitry receiving the data from the respective network interface.

The network interface may comprise a wireless network adaptor, an Ethernet network card, or any suitable device that provides an interface to a network. The network interface may be communicatively coupled to the memory, such that the network interface is able to send data stored on the memory across the network and store received data on the memory. The network interface may also be communicatively coupled to the circuitry (e.g., computer circuitry or processor circuitry) such that the circuitry is able to control operation of the communication interface. The network interface, memory, and circuitry may be communicatively coupled through a system bus, mother board, or using any other suitable manner as will be understood by one of ordinary skill in the art.

The memory 16, 20 may be any suitable computer readable medium, such as one or more of a buffer, a flash memory, a hard drive, a removable media, a volatile memory, a non-volatile memory, a random-access memory (RAM), or other suitable device. In a typical arrangement, the memory 16, 20 may include a non-volatile memory for long term data storage and a volatile memory that functions as system memory for the processor 16. The memory 16, 20 may exchange data with the processor circuitry 18 and computer circuitry 22 over a data bus. Accompanying control lines and an address bus between the memory 16, 20 and the processor circuitry 18 and computer circuitry 22 may also be present. The memory 16, 20 is considered a non-transitory computer readable medium.

The computer device 12 may encompass a range of configurations and designs. For example, the computer device (also referred to as a computer) 12 may be implemented as a single device, such as a server, desktop computer, laptop, or other standalone units. These individual devices may incorporate essential components like a central processing unit (CPU), memory modules (including random-access memory (RAM) and read-only memory (ROM)), storage devices (like solid-state drives or hard disk drives), and various input/output (I/O) interfaces. Alternatively, the computer device might constitute a network of interconnected computer devices, forming a more complex and integrated system. This could include server clusters, distributed computing environments, or cloud-based infrastructures, where multiple devices are linked via network interfaces to work cohesively, often enhancing processing capabilities, data storage, and redundancy.

The external email server platform 14 may encompass a range of configurations and architectures. For example, the external email server platform 14 may be implemented as a single server, such as an on-premises email server like Microsoft Exchange Server, or as a cloud-based email service provided by platforms like Microsoft Office 365 or Google Workspace. These individual servers incorporate essential components such as mail transfer agents (MTAs), mail delivery agents (MDAs), and support for standard email protocols including Simple Mail Transfer Protocol (SMTP), Internet Message Access Protocol (IMAP), and Post Office Protocol (POP3). Alternatively, the external email server platform may constitute a network of interconnected email servers, forming a more complex and integrated email system. This could include server clusters, distributed email infrastructures, or hybrid environments that combine on-premises and cloud-based resources. In such configurations, multiple servers are linked via network interfaces to work cohesively, enhancing email processing capabilities, data storage, redundancy, and scalability.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above-described processes including portions thereof can be performed by software, hardware, and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.
system 10
computer device 12
external email server platform 14
memory 16 (computer device)
processor circuitry 18 (computer device)
memory 20 (external email server platform)
computer circuitry 22 (external email server platform)
inbox 26
email filter 30
monitored email 32
status updates 36
email interaction notification 40
dashboard 44
simulated phishing email 46
request for quarantined phishing emails 47
quarantined phishing emails 48
user attack profile 50
status update request 54
undoing API call 60

1. A method implemented by processor circuitry of a computer device for managing an email training campaign sent to a user using an external mail server having an application programming interface (API), the method comprising:
receiving with the processor circuitry an email address of the user;
sending, as a monitored email, an email to the user email address by initiating with the processor circuitry an API call to the external email server platform using the API, such that the monitored email:
bypasses an email filter of the external email server platform; and
is received in an inbox for the email address of the user on the external email server platform;
tracking the monitored email using status updates by:
when the monitored email is received in the inbox for the email address of the user on the external email server platform, sending with the external email server platform to the processor circuitry the receipt of the monitored email as a status update; and
when the user interacts with the monitored email:
receiving with the external email server platform a notification of the user interaction with the monitored email as an email interaction; and
sending with the external email server platform to the processor circuitry the received email interaction notification as the status update;
receiving with the processor circuitry the status update;
generating with the processor circuitry a dashboard based on the received status updates; and
outputting with the processor circuitry the generated dashboard.

2. The method of claim 1, wherein:
the monitored email has a unique identifier; and
the external email server platform receives as a monitored email identifier the unique identifier of the monitored email from the processor circuitry;
the API is a notification based API, such that:
when the user interacts with an email, the email interaction notification received by the external email server platform includes a unique identifier of the email the user interacted with; and
when the received unique identifier matches the monitored email identifier, the external email server platform automatically sends the received email interaction notification to the processor circuitry as the status update.

3. The method of claim 1, wherein
the monitored email has a unique identifier;
the API is a polling API, such that:
when the user interacts with an email, the email interaction notification received by the external email server platform includes a unique identifier of the email the user interacted with; and
when the external email server platform receives the email interaction notification, the external email server platform waits to send to the processor circuitry the received email interaction notification as the status update until after receiving the external email server platform receives a status update request from the processor circuitry;
the method further comprises:
the processor circuitry sending the status update request to the external email server platform including the unique identifier of the monitored email as a monitored email identifier;
the external email server platform receiving the status update request from the processor circuitry;
identifying with the external email server platform an email matching the received email identifier;
determining with the external email server platform a status of the identified email; and
the external email server platform sending the determined status of the email to the processor circuitry as the status update.

4. The method of claim 1, wherein the user interaction includes at least one of opening the monitored email, moving the monitored email to a junk folder, deleting the monitored email, replying to the monitored email, or reporting the monitored email as a phishing email.

5. The method of claim 1, wherein the sending of the monitored email by initiating the API call includes at least one of marking the monitored email as important, pinning a position of the monitored email to a top of the inbox, or setting a reminder associated with the monitored email.

6. The method of claim 1, wherein the monitored email is a simulated phishing email.

7. The method of claim 6, further comprising:
generating the simulated phishing email by:
requesting with the processor circuitry from the external email server platform quarantined phishing emails received by the user;
sending with the external email server platform to the processor circuitry the requested quarantined phishing emails;
receiving with the processor circuitry the quarantined phishing emails;
generating with the processor circuitry a user attack profile based on a type of the received quarantined phishing emails; and
creating the phishing email based on the generated user attack profile, such that properties of the created phishing email match properties of the quarantined phishing emails.

8. The method of claim 1, wherein:
the user is one of a plurality of users;
the method further comprises sending multiple monitored emails to each of the plurality of users; and
the generated dashboard describes user interactions with the sent monitored emails by the plurality of users.

9. The method of claim 1, further comprising after receiving with the processor circuitry the status update, and when the user interaction includes at least one of moving the monitored email to a junk folder, marking the monitored email as read, or deleting the monitored email:
initiating with the processor circuitry an undoing API call to the external email server platform using the API, such that the result of the user interaction with the monitored email is reversed.

10. A computer device for managing an email training campaign sent to a user using an external mail server having an application programming interface (API), the computer device comprising:
processor circuitry configured to:
receive an email address of the user;
send, as a monitored email, an email to the user email address by initiating an API call to the external email server platform using the API, such that the monitored email:
bypasses an email filter of the external email server platform; and
is received in an inbox for the email address of the user on the external email server platform;
track the monitored email using status updates by receiving status updates from the external email server platform when the monitored email is received in the inbox for the email address of the user on the external email server platform or when the user interacts with the monitored email;
generating with the processor circuitry a dashboard based on the received status updates; and
outputting the generated dashboard.

11. The computer device of claim 10, wherein
the monitored email has a unique identifier;
the API is a polling API, such that when the user interacts with an email, the email interaction notification received by the external email server platform includes a unique identifier of the email the user interacted with; and
the processor circuitry is further configured to:
send a status update request to the external email server platform including the unique identifier of the monitored email as a monitored email identifier; and
receive from the external email server platform the status update based on the received email interaction notification.

12. The computer device of claim 10, wherein the user interaction includes at least one of opening the monitored email, moving the monitored email to a junk folder, deleting the monitored email, replying to the monitored email, or reporting the monitored email as a phishing email.

13. The computer device of claim 10, wherein the sending of the monitored email by initiating the API call includes at least one of marking the monitored email as important, pinning a position of the monitored email to a top of the inbox, or setting a reminder associated with the monitored email.

14. The computer device of claim 10, wherein the monitored email is a simulated phishing email.

15. The computer device of claim 14, wherein the processor circuitry is further configured to generate the simulated phishing email by:
requesting from the external email server platform quarantined phishing emails received by the user;
receiving the quarantined phishing emails;
generating a user attack profile based on a type of the received quarantined phishing emails; and
creating the phishing email based on the generated user attack profile, such that properties of the created phishing email match properties of the quarantined phishing emails.

16. The computer device of claim 10, wherein:
the user is one of a plurality of users;
the processor circuitry is further configured to send multiple monitored emails to each of the plurality of users; and
the generated dashboard describes user interactions with the sent monitored emails by the plurality of users.

17. The computer device of claim 10, wherein after receiving the status update and when the user interaction includes at least one of moving the monitored email to a junk folder, marking the monitored email as read, or deleting the monitored email, the processor circuitry is further configured to:
initiate an undoing API call to the external email server platform using the API, such that the result of the user interaction with the monitored email is reversed.

18. A system for managing an email training campaign sent to a user comprising:
an external email server platform storing an inbox for the email address of the user, wherein the external email server platform includes computer circuitry configured to receive and execute requests formatted according to an application programming interface (API) and to implement an email filter;
a computer device including processor circuitry configured to:
receive an email address of the user;
send, as a monitored email, an email to the user email address by initiating an API call to the external email server platform using the API, such that the monitored email:
bypasses the email filter of the external email server platform; and
is received in the inbox for the email address of the user;
track the monitored email by receiving status updates from the external email server platform;
wherein the computer circuitry of the external email server platform is further configured to:
receive the monitored email in the inbox for the email address of the user;
send to the processor circuitry the receipt of the monitored email as a status update;
when the user interacts with the monitored email:
receive a notification of the user interaction with the monitored email as an email interaction notification; and
send to the processor circuitry the received email interaction notification as the status update;
wherein the processor circuitry of the computer device is further configured to:
generate a dashboard based on the received status updates; and
output the generated dashboard.

19. The system of claim 18, wherein the user interaction includes at least one of opening the monitored email, moving the monitored email to a junk folder, deleting the monitored email, replying to the monitored email, or reporting the monitored email as a phishing email.

20. The system of claim 18, wherein:
the monitored email is a simulated phishing email;
the computer circuitry of the external email server platform is further configured to:
receive from the computer device a request for quarantined phishing emails; and
send to the computer device the requested quarantined phishing emails the processor circuitry is further configured to:
receive the quarantined phishing emails;
generate a user attack profile based on a type of the received quarantined phishing emails; and
create the phishing email based on the generated user attack profile, such that properties of the created phishing email match properties of the quarantined phishing emails.
